(19) United States
(12) Patent Application Publication
(10) Pub. No.: US 2025/0322778 A1
(43) Pub. Date: Oct. 16, 2025

(54) DISPLAY APPARATUS AND METHOD OF DRIVING DISPLAY PANEL USING THE SAME

(71) Applicant: Samsung Display Co., LTD., Yongin-si (KR)

(72) Inventors: GI-NA YOO, Yongin-si (KR); HYOMIN KIM, Yongin-si (KR); ILLSOO PARK, Yongin-si (KR); SIJIN SUNG, Yongin-si (KR)

(21) Appl. No.: 19/010,483

(22) Filed: Jan. 6, 2025

(30) Foreign Application Priority Data
Apr. 11, 2024 (KR) 10-2024-0048423

(51) Int. Cl. G09G 3/20

(52) U.S. Cl. CPC G09G 3/2092; G09G 2310/0275; G09G 2320/0257; G09G 2360/16

(57) ABSTRACT

A display apparatus includes a display panel including a pixel, a data driver which applies a data voltage based on a data signal to the pixel and a driving controller which receives input image data and outputs the data signal. The driving controller generates the data signal based on a luminance gain calculated based on a luminance recognition test data and a color sense gain calculated based on a color sense recognition test data.

This application claims priority to Korean Patent Application No. 10-2024-0048423, filed on Apr. 11, 2024, and all the benefits accruing therefrom under 35 U.S.C. § 119, the content of which in its entirety is herein incorporated by reference.

### BACKGROUND

### 1. Field

Embodiments of the invention relate to a display apparatus and a method of driving the display apparatus. More particularly, embodiments of the invention relate to a display apparatus with improved display quality and a method of driving the display apparatus.

### 2. Description of the Related Art

Generally, a display apparatus includes a display panel and a display panel driver. The display panel may include a plurality of gate lines, a plurality of data lines and a plurality of pixels. The display panel driver may include a gate driver for providing a gate signal to the gate lines, a data driver for providing a data voltage to the data lines and a driving controller for controlling the gate driver and the data driver.

Genarally, an afterimage may be visible in a display apparatus over time due to a driving time and a deterioration of a display panel thereof.

### SUMMARY

Embodiments of the invention provide a display apparatus which delays a timepoint at which an afterimage on the display panel is visible.

Embodiments of the invention also provide a method of driving display panel using the display apparatus.

According to embodiments, a display apparatus includes a display panel including a pixel, a data driver which applies a data voltage based on a data signal to the pixel and a driving controller which receives input image data and outputs the data signal. In such embodiments, the driving controller generates the data signal based on a luminance gain calculated based on a luminance recognition test data and a color sense gain calculated based on a color sense recognition test data.

In an embodiment, the data signal may be generated based on a final gain, and the final gain may be a product of the luminance gain and the color sense gain.

In an embodiment, a luminance level may be determined based on the luminance recognition test data. In such an embodiment, the luminance gain may have a second luminance gain higher than a first luminance gain when the luminance level is in a second luminance level higher than a first luminance level.

In an embodiment, a luminance level may be determined based on the luminance recognition test data. In such an embodiment, when the luminance level is increased, the luminance gain may be increased.

In an embodiment, the final gain may include a first color final gain, a second color final gain and a third color final gain. In such an embodiment, the first color final gain may be a product of a first color sense gain and the luminance gain, the second color final gain may be a product of a second color sense gain and the luminance gain, and the third color final gain may be a product of a third color sense gain and the luminance gain.

In an embodiment, the first color sense gain may be higher than a first reference gain when a color sense level determined based on the color sense recognition test data is in a first color sense level range, the second color sense gain may be higher than a second reference gain when the color sense level is in a second color sense range different from the first color sense level range, and the third color sense gain may be higher than a third reference gain when the color sense level is in a third color sense range different from the first color sense level range and the second color sense level range.

In an embodiment, the luminance recognition test data may have a value determined based on a selected luminance selected from a test image, and the color sense recognition test data has a value based on a selected color selected from the test image. In such an embodiment, when the selected color is a first color, the first color sense gain may be a maximum color sense gain.

In an embodiment, a first color luminance of the display panel may be controlled based on the first color final gain, a second color luminance of the display panel may be controlled based on the second color final gain, and a third color luminance of the display panel may be controlled based on the third color final gain.

In an embodiment, the luminance recognition test data may have a value based on a selected luminance selected from a test image. In such an embodiment, the color sense recognition test data may have a value determined based on a selected color selected from the test image.

In an embodiment, the test image may include a luminance test image and a color sense test image. In such an embodiment, The luminance test image may include a first luminance image and a second luminance image. In such an embodiment, The first luminance image may include a first luminance region, and the second luminance image may include a second luminance region having a luminance lower than a luminance of the first luminance region.

In an embodiment, the test image may include a luminance test image and a color sense recognition test image. In such an embodiment, the color sense test image may include a first color region having a first color and a second color region having a second color different from the first color.

In an embodiment, the test image may include a luminance test image and a color sense test image. In such an embodiment, the luminance test image may include a first luminance region, a second luminance region having a luminance lower than a luminance of the first luminance region and a third luminance region having a luminance lower than a luminance of the second luminance region.

In an embodiment, the driving controller may include a luminance data calculator which determines a luminance level based on the luminance recognition test data, a color sense data calculator which determines a color sense level based on the color sense recognition test data, a gain calculator which calculates a final gain based on the luminance level and the color sense level and a signal outputter which generates the data signal based on the final gain and the input image data.

In an embodiment, the driving controller further may include a stress converter which determines a deterioration of the display panel and outputs deterioration data corresponding to the deterioration of the display panel, and a compensation signal generator which receives the deterioration data and the final gain, and outputs a compensation signal generated based on the deterioration data and the final gain.

According to embodiments, a method of driving a display panel includes driving the display panel for displaying a test image, receiving test data based on the test image, calculating a luminance gain and a color sense gain based on the test data and generating a data signal based on the luminance gain and the color sense gain.

In an embodiment, the data signal may be generated based on a final gain. In such an embodiment, the final gain may be a product of the luminance gain and the color sense gain.

In an embodiment, the test data may include a luminance recognition test data. In such an embodiment, a luminance level may be determined based on the luminance recognition test data. In such an embodiment, when the luminance level is increased, the luminance gain may be increased.

In an embodiment, wherein the test data may include a luminance recognition test data. In such an embodiment, a luminance level may be determined based on the luminance recognition test data. In such an embodiment, the luminance gain may have a second luminance gain higher than a first luminance gain when the luminance level is in a second luminance level higher than a first luminance level.

In an embodiment, the final gain may include a first color final gain, a second color final gain and a third color final gain. In such an embodiment, the first color final gain may be a product of a first color sense gain and the luminance gain, the second color final gain may be a product of a second color sense gain and the luminance gain, and the third color final gain may be a product of a third color sense gain and the luminance gain.

In an embodiment, the first color sense gain may be higher than a first reference gain when a color sense level determined based on the test data is in a first color sense level range, the second color sense gain may be higher than a second reference gain when the color sense level is in a second color sense range different from the first color sense level range, and the third color sense gain may be higher than a third reference gain when the color sense level is in a third color sense range different from the first color sense level range and the second color sense level range.

As described above, according to embodiments of the display apparatus and the method of driving the display panel, a display panel may display an image based on a final compensation luminance. The final compensation luminance may be determined based on deterioration data and test data. The test data may be a value considering (determined based on) a luminance change recognition and a color sense change recognition of a user. Accordingly, a display quality of the display panel may be improved. In such embodiments, the display panel may display an image considering the luminance change recognition and the color sense change recognition of the user, such that a timepoint which the user recognizes an afterimage may be delayed. Accordingly, a timepoint which the user recognizes the display panel as defective may be delayed.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display apparatus according to embodiments of the invention.

FIG. 2 is a block diagram illustrating an embodiment of a driving controller of FIG. 1.

FIG. 3 is a diagram illustrating an example of a test image displayed on a display panel of FIG. 1.

FIG. 4 is a diagram illustrating an example of a test image displayed on the display panel of FIG. 1.

FIG. 5 is a diagram illustrating an example of a test image displayed on a display panel of FIG. 1.

FIG. 6 is a diagram illustrating an example of a test image displayed on a display panel of FIG. 1.

FIG. 7 is a graph illustrating a luminance level determined by a driving controller of FIG. 1.

FIG. 8 is a graph illustrating color sense level determined by a driving controller of FIG. 1.

FIG. 9 is a graph illustrating a luminance gain corresponding to a luminance level of FIG. 7.

FIG. 10 is a graph illustrating a first color sense gain corresponding to a color sense level of FIG. 8.

FIG. 11 is a graph illustrating a second color sense gain corresponding to a color sense level of FIG. 8.

FIG. 12 is a graph illustrating a third color sense gain corresponding to a color sense level of FIG. 8.

FIG. 13 is a graph illustrating a lifetime according to driving time of display panel of FIG. 1.

FIG. 14 is a graph illustrating a luminance level determined by a driving controller of FIG. 1.

FIG. 15 is a block diagram illustrating an embodiment of a driving controller of FIG. 1.

FIG. 16 is a flowchart illustrating an embodiment of a method of driving a display panel of FIG. 1.

FIG. 17 is a block diagram illustrating an electronic device according to an embodiment of the invention.

FIG. 18 is a diagram illustrating an embodiment in which the electronic device of FIG. 17 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

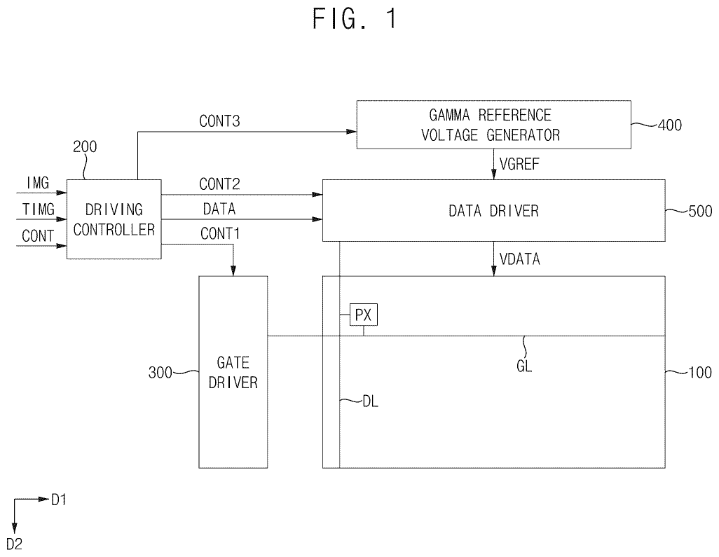

FIG. 1 is a block diagram illustrating a display apparatus 1 according to embodiments of the invention.

Referring to FIG. 1, an embodiment of the display apparatus 1 includes a display panel 100 and a display panel driver. In an embodiment, the display panel driver includes a driving controller 200, a gate driver 300, a gamma reference voltage generator 400 and a data driver 500. In an embodiment, the display apparatus 1 may further include an emission driver 600 and a voltage generator 700.

The display panel 100 has a display region, on which an image is displayed, and a peripheral region adjacent to the display region.

The display panel 100 includes a plurality of gate lines GL, plurality of emission lines EL, a plurality of data lines DL and a plurality of pixels electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

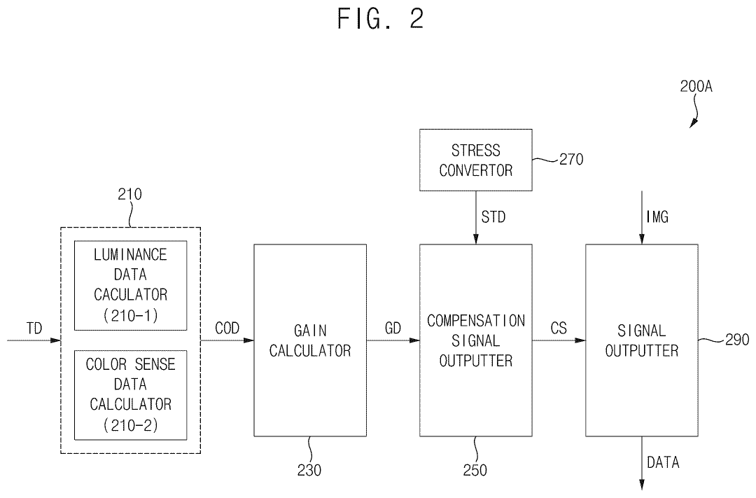

The driving controller 200 receives input image data IMG, test image data TIMG and an input control signal CONT from an external apparatus. In an embodiment, the driving controller 200 may further receive test data TD of FIG. 2 from an external apparatus. In an embodiment, for example, the input image data IMG may include red image data, green image data and blue image data. The input image data IMG may include white image data. The input image data IMG may include magenta image data, cyan image data and yellow image data. In an embodiment, for example, the test image data TIMG may include red image data, green image data and blue image data. The test image data TIMG may include white image data. The test image data TIMG may include magenta image data, cyan image data and yellow image data. In an embodiment, for example, the test data TD of FIG. 2 may be generated based on the test image data TIMG. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3 and a data signal DATA based on the input image data IMG, the test image data TIMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT and outputs the third control signal CONT3 to the gamma reference voltage generator 400.

The gate driver 300 generates gate signals driving the gate lines GL in response to the first control signal CONT1 received from the driving controller 200. The gate driver 300 may output the gate signals to the gate lines GL. In an embodiment, the gate signals may include a write gate signal, a compensation signal, an initialization gate signal and a bias gate signal.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL.

In an embodiment, the data driver 500 may be disposed in the peripheral region. In an embodiment, the data driver 500 may be integrated in the peripheral region.

FIG. 2 is a block diagram illustrating an embodiment of a driving controller 200 of FIG. 1.

Referring to FIG. 1 and FIG. 2, an embodiment of a driving controller 200A may include a data calculator 210, a gain calculator 230, a compensation signal outputter 250, a stress converter 270 and a signal outputter 290.

The data calculator 210 may receive test data TD. The data calculator 210 may output calculation data COD generated based on the test data TD to the gain calculator 230. The data calculator 210 may include a luminance data calculator 210-1 and a color sense data calculator 210-2. The test data TD may include luminance recognition test data and a color sense recognition test data.

The gain calculator 230 may receive the calculation data COD. The gain calculator 230 may output a final gain GD calculated based on the calculation data COD to the compensation signal outputter 250.

The compensation signal outputter 250 may receive the final gain GD from the gain calculator 230 and receive deterioration data STD from the stress converter 270. The compensation signal outputter 250 may generate a compensation signal CS generated based on the final gain GD and the deterioration data STD to the signal outputter 290.

The stress converter 270 may determine a cumulative deterioration of the display panel 100. In an embodiment, the cumulative deterioration may be a value considering (determined based on) a temperature, a driving time, etc. of the display panel 100. In an embodiment, for example, the stress converter 270 may output deterioration data STD corresponding to the cumulative deterioration to the compensation signal outputter 250. In another embodiment, for example, the cumulative deterioration may be determined based on the input image data IMG.

The signal outputter 290 may receive the input image data IMG from an outside and receive the compensation signal CS from the compensation signal outputter 250. The signal outputter 290 may convert the input image data IMG based on the compensation signal CS. In an embodiment, for example, the signal outputter 290 may convert a luminance of the input image data IMG based on the compensation signal CS. In an embodiment, for example, when a luminance of a first region of the display panel 100 is reduced by the cumulative deterioration, a luminance education of the first region may be compensated based on the compensation signal CS. In an embodiment, an operation of compensating the luminance reduction may be called as a compensation operation. In an embodiment, for example, when the first region emits as a first emission luminance based on the input image data IMG, the first region may emit as a second emission luminance lower than the first emission luminance by the cumulative deterioration. In such an embodiment, if the display panel 100 emits as the second emission luminance lower than the first emission luminance, a display quality of the display panel 100 may be reduced. In an embodiment, for example, the compensation operation may compensate the second emission luminance to have a deterioration compensation luminance similar to the first emission luminance based on the deterioration data STD. The compensation operation may compensate the second emission luminance to have a final compensation luminance similar to the first emission luminance based on the final gain GD and the deterioration data STD. Accordingly, an effect of the cumulative deterioration may be reduced. The signal outputter 290 may output the data signal DATA based on the converted input image data.

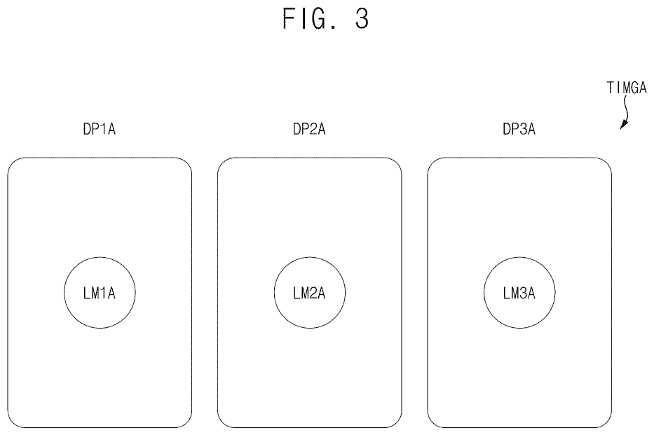

FIG. 3 is a diagram illustrating an example of a test image displayed on a display panel 100 of FIG. 1.

Referring to FIG. 1 to FIG. 3, an embodiment of the display panel 100 may display a test image TIMGA based on the test image data TIMG.

In an embodiment, the test image TIMGA may be a luminance test image. The test image TIMGA may include a first luminance image DP1A, a second luminance image DP2A and a third luminance image DP3A. The first luminance image DP1A may include a first background region and a first luminance region LM1A. The first luminance region LM1A may emit light with a first test luminance. The first background region may emit light with a background luminance. In an embodiment, for example, the background luminance may be about 100%. The second luminance image DP2A may include a second background region and a second luminance region LM2A. The second luminance region LM2A may emit light with a second test luminance. The second background region may emit light with the background luminance. The second test luminance may be lower than the first test luminance. The third luminance image DP3A may include a third background region and a third luminance region LM3A. The third luminance region LM3A may emit light with a third test luminance. The third background region may emit light with the background luminance. The third test luminance may be lower than the second test luminance. However, the invention is not limited to the number of luminance images included in the test image TIMGA shown in FIG. 3. In an embodiment, for example, the number of the luminance images may be set by setter. Additionally, the invention is not limited to a shape of the luminance regions shown in FIG. 3.

The first test luminance may be lower than the background luminance. In an embodiment, for example, the first test luminance may be about 99%. The second test luminance may be lower than the background luminance. In an embodiment, for example, the second test luminance may be about 98%. The third test luminance may be lower than the background luminance. In an embodiment, for example, the third test luminance may be about 97%. However, the invention is not limited to a value of the test luminance described above.

In an embodiment, for example, when a user selects a first luminance image DP1A, the display panel 100 may display the second luminance image DP2A. In an embodiment, for example, when the user does not select the second luminance region LM2A of the second luminance image DP2A within a certain time, the first test luminance may be a selected luminance. In an embodiment, for example, the test image TIMGA may further include a completion region. In an embodiment, for example, when the user selects the completion region of the third luminance image DP3A, the second test luminance may be the selected luminance. The luminance recognition test data may be determined based on the selected luminance. In an embodiment, for example, the luminance recognition test data may have a value based on the selected luminance. In an embodiment, the selection of the user may be selected by a touch of the user.

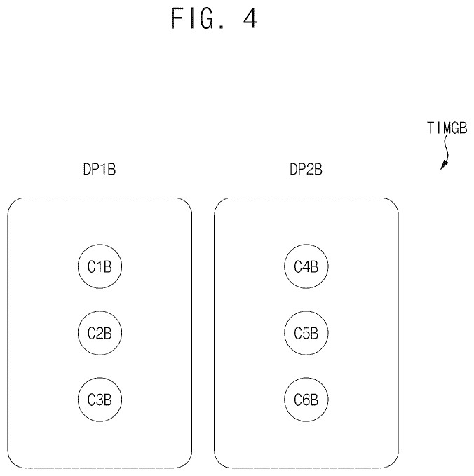

FIG. 4 is a diagram illustrating an example of a test image displayed on the display panel 100 of FIG. 1.

Referring to FIG. 1, FIG. 2 and FIG. 4, an embodiment of the display panel 100 may display a test image TIMGB based on the test image data TIMG.

In an embodiment, the test image TIMGB may be a color sense test image. The test image TIMGB may include a first color sense image DP1B and a second color sense image DP2B. The first color sense image DP1B may include a first color region C1B, a second color region C2B and a third color region C3B. In an embodiment, for example, the first color region C1B may emit light of a red color. In such an embodiment, the second color region C2B may emit light of a green color. In such an embodiment, the third color region C3B may emit light of a blue color. The second color sense image DP2B may include a fourth color region C4B, a fifth color region C5B and a sixth color region C6B. In an embodiment, for example, the fourth color region C4B may emit light of a magenta color. In such an embodiment,, the fifth color region C5B may emit light of a cyan color. In such an embodiment, the sixth color region C6B may emit light of a yellow color. In such an embodiment, the test image TIMGB may only include the first color sense image DP1B or the second color sense image DP2B. However, the invention is not limited to a color which the first to sixth color regions C1B, C2B, C3B, C4B, C5B and C6B emit. In an embodiment, for example, a wavelength of the first color region CIB and a wavelength of the second color region C2B may be different from each other. Additionally, the invention is not limited to the number of color sense images included in the test image TIMGB. In an embodiment, for example, the first to sixth color regions C1B, C2B, C3B, C4B, C5B and C6B may be included in one color sense test image. In an embodiment, for example, the number of the color sense image may be set by a setter. Additionally, the invention is not limited to a shape of the color regions shown in FIG. 4. In an embodiment, for example, when the user selects the first color region C1B, a color of the first color region C1B may be a selected color. In an embodiment, for example, when the user selects the second color region C2B, a color of the second color region C2B may be the selected color. Color sense test data may be determined based on the selected color. In an embodiment, for example, the color sense test data may have a value based on the selected color. In an embodiment, the selection of the user may be selected by a touch of the user.

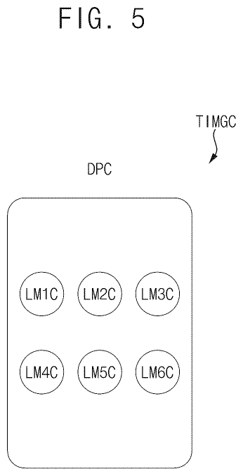

FIG. 5 is a diagram illustrating an example of a test image displayed on a display panel 100 of FIG. 1.

Referring to FIG. 1, FIG. 2 and FIG. 5, an embodiment of the display panel 100 may display a test image TIMGC based on the test image data TIMG.

In an embodiment, the test image TIMGC may be the luminance test image. The test image TIMGC may include a luminance image DPC. The luminance image DPC may include first to sixth luminance regions LM1C, LM2C, LM3C, LM4C, LM5C and LM6C. The first luminance region LM1C may emit light with the first test luminance. The second luminance region LM2C may emit light with the second test luminance. The third luminance region LM3C may emit light with the third test luminance. The fourth luminance region LM4C may emit light with a fourth test luminance. The fourth test luminance may be lower than the third test luminance. The fifth luminance region LM5C may emit light with a fifth test luminance. The fifth test luminance may be lower than the fourth test luminance. The sixth luminance region LM6C may emit light with a sixth test luminance. The sixth test luminance may be lower than the fifth test luminance. However, the invention is not limited to a shape of the luminance regions. In an embodiment, for example, when the user selects the third luminance region LM3C, the third test luminance may be the selected luminance. In an embodiment, for example, when the user selects the fifth luminance region LM5C, the fifth test luminance may be the selected luminance. In an embodiment, the selection of the user may be selected by a touch of the user.

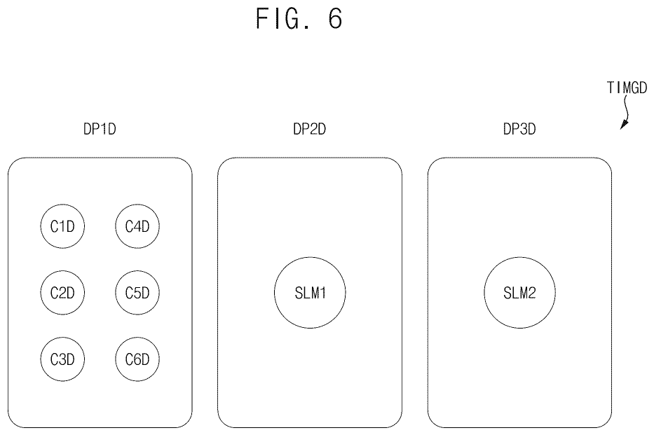

FIG. 6 is a diagram illustrating an example of a test image displayed on a display panel 100 of FIG. 1.

Referring to FIG. 1, FIG. 2 and FIG. 6, an embodiment of the display panel 100 may display an integrated test image TIMGD based on the test image data TIMG.

In an embodiment, the integrated test image TIMGD may include a first test image DP1D, a second test image DP2D and a third test image DP3D.

The first test image DP1D may be the color sense test image. The first test image DP1D may include first to sixth color regions C1D, C2D, C3D, C4D, C5D and C6D. In an embodiment, for example, each region of the first to sixth color regions C1D, C2D, C3D, C4D, C5D and C6D may emit light of different wavelengths. A color of selected region selected from the first to sixth color regions C1D, C2D, C3D, C4D, C5D and C6D may be the selected color. The second test image DP2D may be include a first selected luminance region SLM1 having the selected color. The first selected luminance region SLM1 may emit as the first test luminance. The third test image DP3D may be include a second selected luminance region SLM2 having the selected color. The second selected luminance region SLM2 may emit light with the second test luminance. However, the invention is not limited to the number of test images included in the integrated test image TIMGD. In an embodiment, for example, the number of the test images may be set by a setter. Additionally, the invention is not limited to a shape of color regions and luminance regions. In an embodiment, for example, when the user selects the first selected luminance region SLM1, the display panel 100 may display the third test image DP3D. In an embodiment, for example, when the user does not select the second selected luminance region SLM2 of the third test image DP3D within a certain time, the first test luminance may be a selected luminance. In an embodiment, for example, the second to third test images DP2D and DP3D may further include a completion region. In an embodiment, for example, when the user selects the completion region of the third test image DP3D, the first test luminance may be the selected luminance. In an embodiment, for example, the selection of the user may be selected by a touch of the user.

FIG. 7 is a graph illustrating a luminance level 1LEVA determined by a driving controller 200 of FIG. 1.

Referring to FIG. 1 to FIG. 7, in an embodiment, the driving controller 200 may determine a luminance level 1LEVA. In an embodiment, for example, the luminance data calculator 210-1 included in the driving controller 200 may determine the luminance level 1LEVA. When the selected luminance is higher than a fifth luminance DRL5A, the luminance level 1LEVA may be a sixth luminance level. When the selected luminance is lower than the fifth luminance DRL5A and higher than a fourth luminance DRL4A, the luminance level 1LEVA may be a fifth luminance level. When the selected luminance is lower than the fourth luminance DRL4A and higher than a third luminance DRL3A, the luminance level 1LEVA may be a fourth luminance level. When the selected luminance is lower than the third luminance DRL3A and higher than a second luminance DRL2A, the luminance level 1LEVA may be a third luminance level. When the selected luminance is lower than the second luminance DRL2A and higher than a first luminance DRL1A, the luminance level 1LEVA may be a second luminance level. When the selected luminance is lower than a first luminance DRL1A, the luminance level 1LEVA may be a first luminance level. However, the invention is not limited to the number of the luminance levels 1LEVA shown in FIG. 7. The calculation data COD may include data of the luminance level 1LEVA.

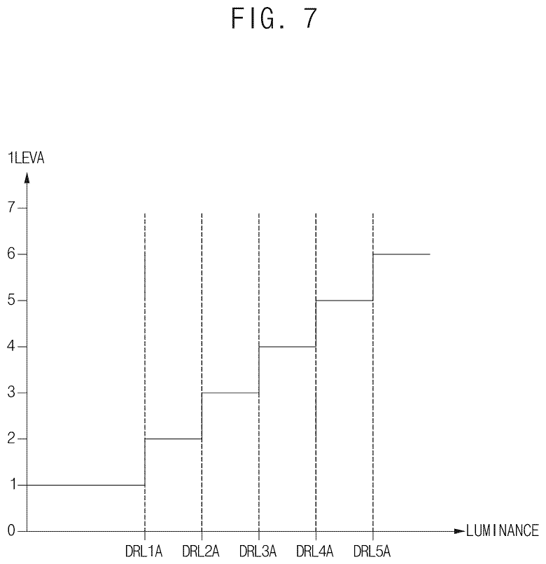

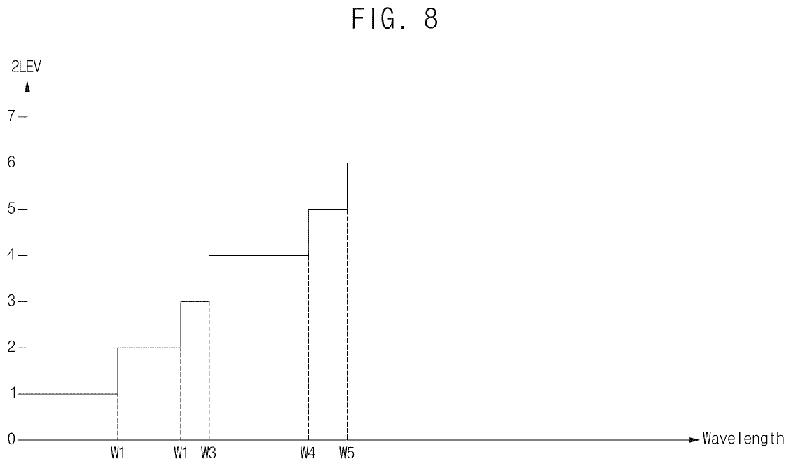

FIG. 8 is a graph illustrating color sense level 2LEV determined by a driving controller 200 of FIG. 1.

Referring to FIG. 1 to FIG. 6 and FIG. 8, in an embodiment, the driving controller 200 may determine a color sense level 2LEV. In an embodiment, for example, the color sense data calculator 210-2 included in the driving controller 200A may determine the color sense level 2LEV. When a wavelength of the selected color is shorter than a first wavelength W1, the color sense level 2LEV may be a first color sense level. When a wavelength of the selected color is longer than the first wavelength W1 and shorter than a second wavelength W2, the color sense level 2LEV may be a second color sense level. When a wavelength of the selected color is longer than the second wavelength W2 and shorter than a third wavelength W3, the color sense level 2LEV may be a third color sense level. When a wavelength of the selected color is longer than the third wavelength W3 and shorter than a fourth wavelength W4, the color sense level 2LEV may be a fourth color sense level. When a wavelength of the selected color is longer than the fourth wavelength W4 and shorter than a fifth wavelength W5, the color sense level 2LEV may be a fifth color sense level. When a wavelength of the selected color is longer than the fifth wavelength W5 and shorter than a sixth wavelength W6, the color sense level 2LEV may be a sixth color sense level. However, the invention is not limited to the number of the color sense levels 2LEV shown in FIG. 8. The calculation data COD may include data of the color sense level 2LEV.

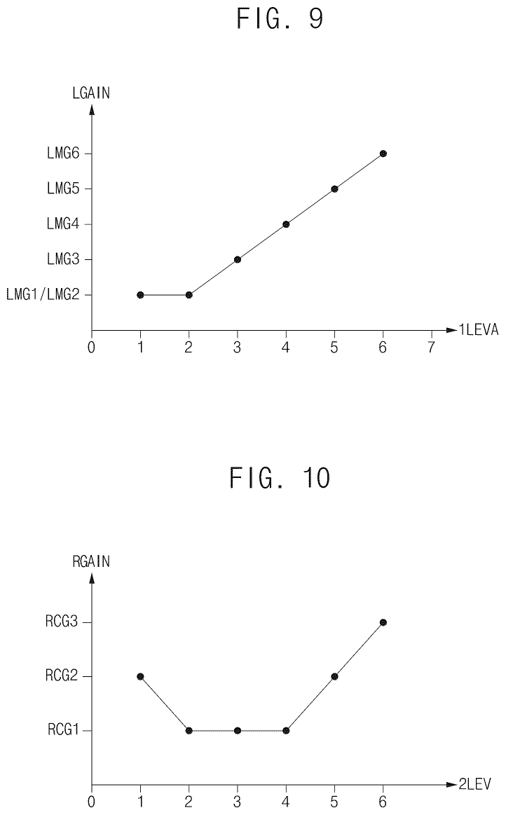

FIG. 9 is a graph illustrating a luminance gain LGAIN corresponding to a luminance level 1LEVA of FIG. 7.

Referring to FIG. 1 to FIG. 9, in an embodiment, the gain calculator 320 may determine the luminance gain LGAIN based on the luminance level 1LEVA. A first luminance gain LMG1 corresponding to the first luminance level may be determined. In an embodiment, for example, the first luminance gain LMG1 may be about 0.98. A second luminance gain LMG2 corresponding to the second luminance level may be determined. In an embodiment, for example, the second luminance gain LMG2 may be about 0.98. In an embodiment, for example, the first luminance gain LMG1 and the second luminance gain LMG2 may be substantially the same as each other. In an embodiment, for example, the second luminance gain LMG2 may be higher than the first luminance gain LMG1. A third luminance gain LMG3 corresponding to the third luminance level may be determined. In an embodiment, for example, the third luminance gain LMG3 may be about 0.99. A fourth luminance gain LMG4 corresponding to the fourth luminance level may be determined. In an embodiment, for example, the fourth luminance gain LMG4 may be about 1. A fifth luminance gain LMG5 corresponding to the fifth luminance level may be determined. In an embodiment, for example, the fifth luminance gain LMG5 may be about 1.01. A sixth luminance gain LMG6 corresponding to the sixth luminance level may be determined. In an embodiment, for example, the sixth luminance gain LMG6 may be about 1.02. In an embodiment, the luminance gain LGAIN corresponding to the luminance level 1LEVA may be stored as look-up table format in the driving controller 200.

When the luminance level 1LEVA becomes higher, the luminance gain LGAIN may be increased. In an embodiment, for example, the sixth luminance gain LMG6 may be higher than the fifth luminance gain LMG5. When a user is sensitive to the luminance change, the luminance level 1LEVA may become higher. The luminance level may become higher, the luminance gain LGAIN may be increased. Accordingly, the final gain GD may be increased.

When the compensation operation is performed, the final gain GD may be considered. In an embodiment, for example, when the user is sensitive to the luminance change, the final gain GD may be increased. When the final gain GD is increased, the finial compensation luminance may be increased. The finial compensation luminance may be increased, so that the timepoint which the user recognizes an afterimage may be delayed.

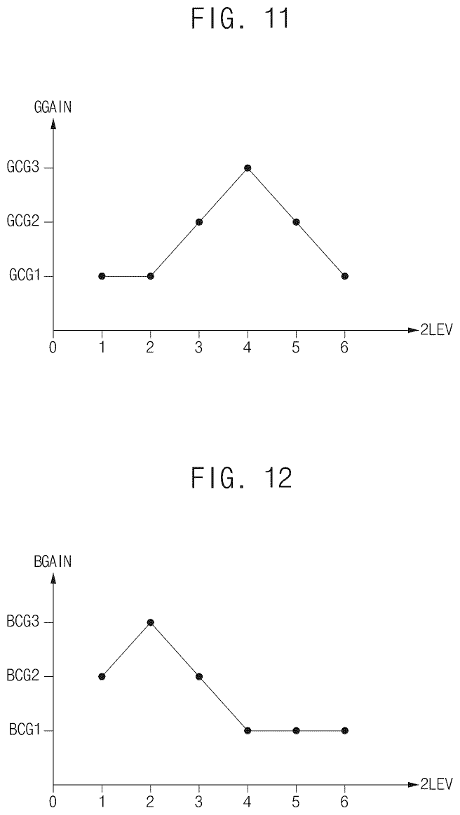

FIG. 10 is a graph illustrating a first color sense gain RGAIN corresponding to a color sense level 2LEV of FIG. 8. FIG. 11 is a graph illustrating a second color sense gain GGAIN corresponding to a color sense level 2LEV of FIG. 8. FIG. 12 is a graph illustrating a third color sense gain BGAIN corresponding to a color sense level 2LEV of FIG. 8.

Referring to FIG. 10 to FIG. 12, the gain calculator 230 may determine a first color sense gain RGAIN based on the color sense level 2LEV. In an embodiment, the first color sense gain RGAIN may be called as a red color sense gain. The first color sense level may correspond to a second red gain RCG2. In an embodiment, for example, the second red gain RCG2 may be about 1.01. The second color sense level may correspond to a first red gain RCG1. In an embodiment, for example, the first red gain RCG1 may be about 1. In an embodiment, the first red gain RCG1 may be called as a reference gain. In an embodiment, the first red gain RCG1 may be called as a red reference gain. The third color sense level may correspond to the first red gain RCG1. The fourth color sense level may correspond to the first red gain RCG1. The fifth color sense level may correspond to the second red gain RCG2. The sixth color sense level may correspond to a third red gain RCG3. In an embodiment, for example, the third red gain RCG3 may be about 1.02. In an embodiment, the third red gain RCG3 may be called as a maximum color sense gain. In an embodiment, the third red gain RCG3 may be called as a red maximum color sense gain.

A first color sense level range may include the first color sense level, the fifth color sense level and the sixth color sense level. In the first color sense level range, the first color sense gain RGAIN may be higher than the reference gain. When the selected color is the first color, the first color sense gain RGAIN may be the maximum color sense gain.

The gain calculator 230 may determine a second color sense gain GGAIN based on the color sense level 2LEV. In an embodiment, the second color sense gain GGAIN may be called as a green color sense gain. The first color sense level may correspond to a first green gain GCG2. In an embodiment, for example, the first green gain GCG1 may be about 1. In an embodiment, the first green gain GCG1 may be called as a reference gain. In an embodiment, the first green gain GCG1 may be called as a green reference gain. The second color sense level may correspond to the first green gain GCG1. The third color sense level may correspond to a second green gain GCG2. In an embodiment, for example, the second green gain GCG2 may be about 1.01. The fourth color sense level may correspond to the third green gain GCG3. In an embodiment, for example, the third green gain GCG3 may be about 1.02. In an embodiment, the third green gain GCG3 may be called as a maximum color sense gain. In an embodiment, the third green gain GCG3 may be called as a green maximum color sense gain. The fifth color sense level may correspond to the second green gain GCG2. The sixth color sense level may correspond to the first green gain GCG1.

A second color sense level range may include the third color sense level to the fifth color sense level. In the second color sense level range, the second color sense gain GGAIN may be higher than the reference gain. When the selected color is the second color, the second color sense gain GGAIN may be the maximum color sense gain.

The gain calculator 230 may determine a third color sense gain BGAIN based on the color sense level 2LEV. In an embodiment, the third color sense gain BGAIN may be called as a blue color sense gain. The first color sense level may correspond to a second blue gain BCG2. In an embodiment, for example, the second blue gain BCG2 may be about 1.01. The second color sense level may correspond to a third blue gain BCG3. In an embodiment, for example, the third blue gain BCG3 may be about 1.02. In an embodiment, the third blue gain BCG3 may be called as a maximum color sense gain. In an embodiment, the third blue gain BCG3 may be called as a blue maximum color sense gain. The fourth color sense level may correspond to a first blue gain GCG3. In an embodiment, the first blue gain BCG1 may be called as a reference gain. In an embodiment, the first blue gain BCG1 may be called as a blue reference gain. The fifth color sense level may correspond to the first blue gain BCG2. The sixth color sense level may correspond to the first blue gain BCG1.

A third color sense level range may include the first color sense level to the third color sense level. In the third color sense level range, the third color sense gain BGAIN may be higher than the reference gain. When the selected color is the third color, the third color sense gain BGAIN may be the maximum color sense gain.

In an embodiment, the first to third color sense gains RGAIN, GGAIN and BGAIN corresponding to the color sense level 2LEV may be stored as a look-up table format in the driving controller 200.

In an embodiment, a luminance of the first color may be changed based on the first color sense gain RGAIN. A luminance of the second color may be changed based on the second color sense gain GGAIN. A luminance of the third color may be changed based on the third color sense gain BGAIN. In an embodiment, for example, when the selected color is the first color, the first color sense gain RGAIN may be the maximum color sense gain. The first color sense gain RGAIN may be the maximum color sense gain, so that the luminance of the first color may be increased. In an embodiment, for example, when the compensation operation is performed, the luminance of the first color may be changed based on the first color sense gain RGAIN. In an embodiment, for example, when the user is sensitive to the first color, the final compensation luminance of the first color may be higher. The final compensation luminance of the first color may be higher, the timepoint which the user recognizes the afterimage may be delayed.

Referring to FIG. 1 to FIG. 12, in an embodiment, the driving controller 200 may perform the compensation operation based on the deterioration data STD and the final gain GD.

The final gain GD may include a first color final gain, a second color final gain and a third color final gain.

The first color final gain may be calculated based on the luminance gain LGAIN and the first color sense gain RGAIN. In an embodiment, for example, the first color final gain may be the product of the luminance gain LGAIN and the first color sense gain RGAIN. In an embodiment, for example, when the luminance LGAIN is the fifth luminance gain LMG5 and the first color sense gain RGAIN is the first red gain RCG1, the first color final gain may be the product of the fifth luminance gain LMG5 and the first red gain RCG1. Accordingly, the final compensation luminance of the first color may be the product of the deterioration compensation luminance and the first color final gain. In an embodiment, for example, when the deterioration compensation luminance is about 90% and the first color final gain is about 1.01, the final compensation luminance of the first color may be about 90.9%. In such an embodiment, a first color luminance of the display panel 100 may be controlled based on the first color final gain. In an embodiment, for example, when the user is sensitive to the first color, the first color final gain may be increased. The first color final gain may be increased, such that the first color luminance may be increased. Accordingly, in such an embodiment when the pixel PX included in the display panel 100 is deteriorated, the first color may not be visible as an afterimage, such that the timepoint which the user recognizes the afterimage may be delayed. Accordingly, the lifetime of the display panel 100 may be increased.

The second color final gain may be calculated based on the luminance gain LGAIN and the second color sense gain GGAIN. In an embodiment, for example, the second color final gain may be the product of the luminance gain LGAIN and the second color sense gain GGAIN. In an embodiment, for example, when the luminance LGAIN is the fourth luminance gain LMG4 and the second color sense gain GGAIN is the third green gain GCG3, the second color final gain may be the product of the fourth luminance gain LMG4 and the third green gain GCG3. Accordingly, the final compensation luminance of the second color may be the product of the deterioration compensation luminance and the second color final gain. In an embodiment, for example, when the deterioration compensation luminance is about 80% and the second color final gain is about 1.02, the final compensation luminance of the second color may be about 81.6%. In such an embodiment, a second color luminance of the display panel 100 may be controlled based on the second color final gain.

The third color final gain may be calculated based on the luminance gain LGAIN and the third color sense gain BGAIN. In an embodiment, for example, the third color final gain may be the product of the luminance gain LGAIN and the third color sense gain BGAIN. In an embodiment, for example, when the luminance LGAIN is the first luminance gain LMG1 and the third color sense gain BGAIN is the first blue gain BCG1, the third color final gain may be the product of the first luminance gain LMG1 and the first blue gain BCG1. Accordingly, the final compensation luminance of the third color may be the product of the deterioration compensation luminance and the third color final gain. In an embodiment, for example, when the deterioration compensation luminance is about 90% and the second color final gain is about 0.98, the final compensation luminance of the second color may be about 88.2%. In such an embodiment, a third color luminance of the display panel 100 may be controlled based on the third color final gain.

In an embodiment, the display panel 100 may display the image based on the final compensation luminance. The final compensation luminance may be determined based on the deterioration data STD of the display panel 100 and the test data TD. The test data TD may be data considering (generated based on) a luminance change recognition and a color sense change recognition of a user. Accordingly, a display quality of the display panel 100 may be improved. Additionally, the display panel 100 may display the image considering (compensated based on) the luminance change recognition and the color sense change recognition of the user, the timepoint which the user recognizes an afterimage may be delayed. Accordingly, the timepoint which the user recognizes the display panel 100 as defective may be delayed.

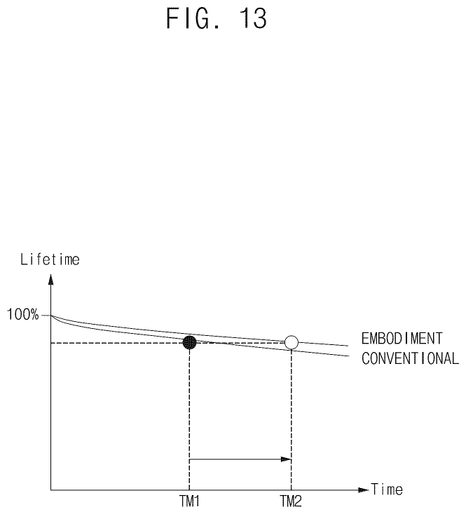

FIG. 13 is a graph illustrating a lifetime according to driving time of display panel 100 of FIG. 1.

Referring to FIG. 1 to FIG. 13, an afterimage of a conventional display panel may be visible to a user in a first time point TM1. Accordingly, the user may recognize the conventional display panel as defective at the first time point TM1.

In contrast, display panel 100 according to an embodiment of the invention may display the image based on the test data TD considering (generated based on) a luminance recognition and a color sense recognition of a user. Accordingly, a timepoint which an afterimage is visible to user may be delayed. In an embodiment, for example, the user may recognize an afterimage at a second time point TM2 after the first time point TM1. Accordingly, the timepoint which the user recognizes the display panel 100 as defective may be delayed.

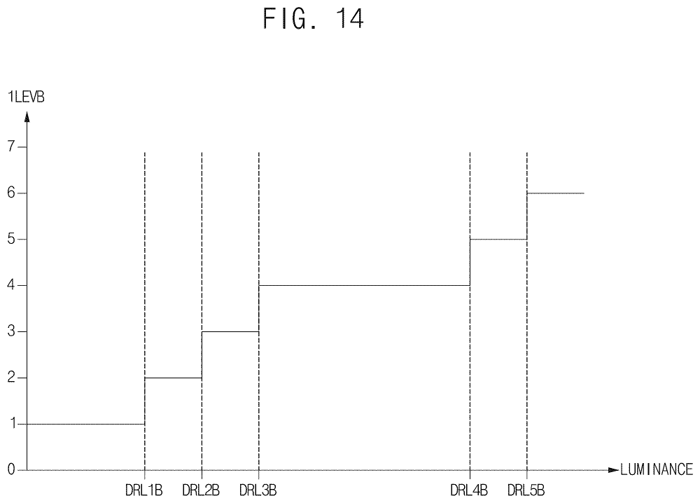

FIG. 14 is a graph illustrating a luminance level 1LEVB determined by a driving controller 200 of FIG. 1.

Referring to FIG. 14, in an embodiment, the driving controller 200 may determine a luminance level 1LEVB. In an embodiment, for example, the luminance data calculator 210-1 included in the driving controller 200 may determine the luminance level 1LEVB. When the selected luminance is higher than a fifth luminance DRL5B, the luminance level 1LEVB may be a sixth luminance level. When the selected luminance is lower than the fifth luminance DRL5B and higher than a fourth luminance DRL4B, the luminance level 1LEVB may be a fifth luminance level. When the selected luminance is lower than the fourth luminance DRL4B and higher than a third luminance DRL3B, the luminance level 1LEVB may be a fourth luminance level. When the selected luminance is lower than the third luminance DRL3B and higher than a second luminance DRL2B, the luminance level 1LEVB may be a third luminance level. When the selected luminance is lower than the second luminance DRL2B and higher than a first luminance DRL1B, the luminance level 1LEVB may be a second luminance level. When the selected luminance is lower than a first luminance DRL1B, the luminance level 1LEVB may be a first luminance level. However, the invention is not limited to the number of the luminance levels 1LEVB shown in FIG. 14. The calculation data COD may include data of the luminance level 1LEVB.

The luminance level 1LEVB is substantially the same as that of the embodiments described above with reference to FIG. 1 to FIG. 7 except for a length of a period having the fourth luminance level. Accordingly, any repetitive detailed description of the same or like elements as those described above will be omitted.

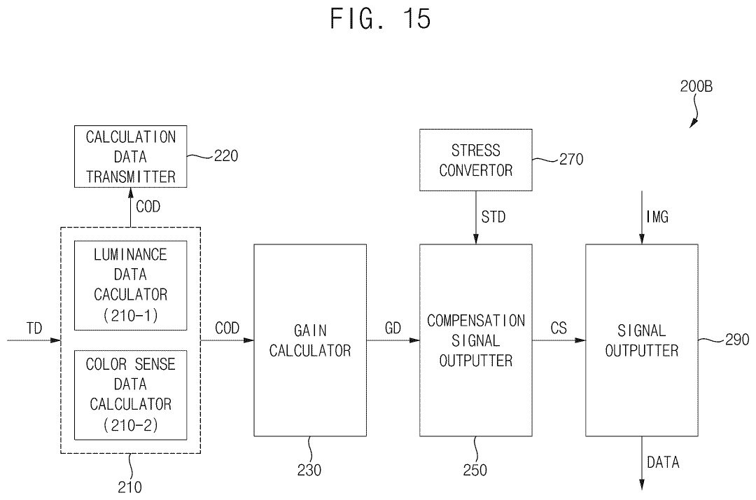

FIG. 15 is a block diagram illustrating an embodiment of a driving controller 200 of FIG. 1.

Referring to FIG. 15, an embodiment of a driving controller 200B may include the data calculator 210, a calculation data transmitter 220, the gain calculator 230, the compensation signal outputter 250, the stress converter 270 and the signal outputter 290.

The driving controller 200B is substantially the same as the embodiment described above with reference to FIG. 1 to FIG. 14 except that the driving controller 200B further includes the calculation data transmitter 220. Accordingly, the same or like elements shown in FIG. 15 are labeled with the same reference characters as used above to describe the embodiment of the driving controller 200A shown in FIG. 2, and any repetitive detailed description thereof will hereinafter be omitted or simplified.

In an embodiment, the driving controller 200B may further include the calculation data transmitter 220.

The calculation data transmitter 220 may store the calculation data COD from the data calculator 210. In an embodiment, for example, the calculation data transmitter 220 may store the luminance level 1LEVA and the color sense level 2LEV generated based on the test data TD. In an embodiment, for example, the calculation data transmitter 220 may store the luminance level 1LEVA and the color sense level 2LEV of a user. In an embodiment, for example, the calculation data transmitter 220 may transmit the luminance level 1LEVA and the color sense level 2LEV to the external apparatus. In an embodiment, for example, transmitted the luminance level 1LEVA and the color sense level 2LEV of the user may be stored in a databased of server. In an embodiment, for example, using the transmitted the luminance level 1LEVA and the color sense level 2LEV, the characteristics (e.g., tendency) of the luminance level 1LEVA and color sense level 2LEV may be determined according to user group (e.g., age, gender, etc.).

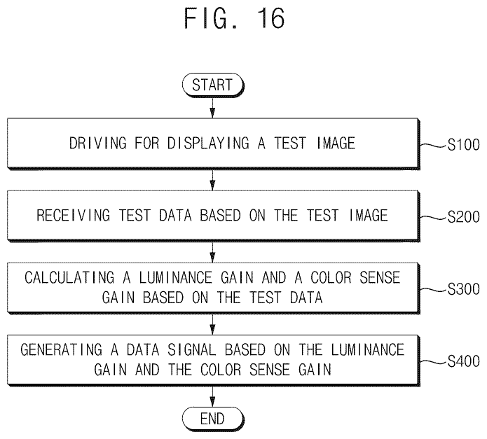

FIG. 16 is a flowchart illustrating an embodiment of a method of driving a display panel 100 of FIG. 1.

Referring to FIG. 1 to FIG. 16, in an embodiment of a method of driving a display panel 100, the display panel driver may drive the display panel 100 for displaying the test image (S100). The display panel driver may receive the test data TD based on the test image (S200). The display panel driver may calculate the luminance gain LGAIN and the color sense gain based on the test data TD (S300). The display panel driver may generate the data signal DATA based on the luminance gain LGAIN and the color sense gain (S400).

In such an embodiment, the display panel 100 may display the image based on the test data TD considering (generated based on) the luminance recognition and the color sense recognition. Accordingly, the timepoint at which the user recognizes the afterimage may be delayed, such that the timepoint which the user recognizes the display panel 100 as defective may be delayed.

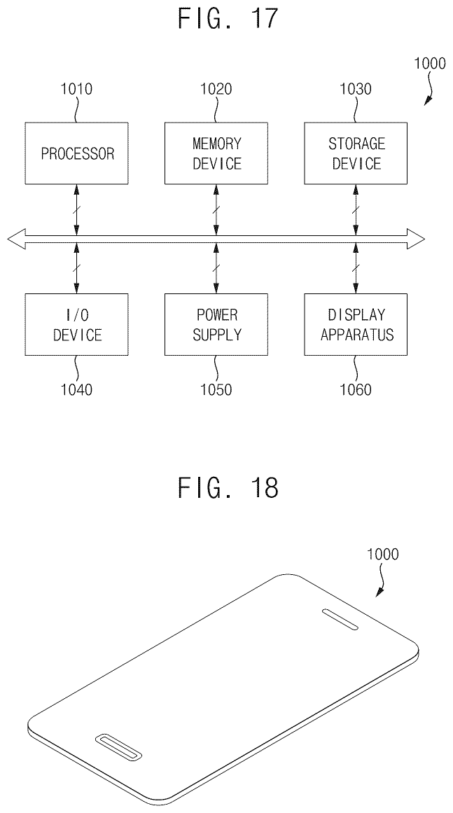

FIG. 17 is a block diagram illustrating an electronic device 1000 according to an embodiment of the invention. FIG. 18 is a diagram illustrating an embodiment in which the electronic device of FIG. 17 is implemented as a smart phone.

Referring to FIG. 17, an embodiment of the electronic device 1000 may include a processor 1010, a memory device 1020, a storage device 1030, an input/output (I/O) device 1040, a power supply 1050, and a display apparatus 1060. Here, the display apparatus 1060 may correspond to the display apparatus 1 of FIG. 1. Additionally, the electronic device 1000 may further include a plurality of ports for communicating with a video card, a sound card, a memory card, a universal serial bus (USB) device, another electronic device, etc.

In an embodiment, as illustrated in FIG. 18, the electronic device 1000 may be implemented as a smart phone. However, the electronic device 1000 is not limited thereto. In another embodiment, for example, the electronic device 1000 may be implemented as any device or product including a display panel such as a cellular phone, a video phone, a smart pad, a smart watch, a tablet computer, a car navigation system, a computer monitor, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1. In an embodiment, the processor 1010 may output the test image data TIMG to the driving controller 200.

The memory device 1020 may store data for operations of the electronic device 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic device 1000. The display apparatus 1060 may be coupled to other components via the buses or other communication links.

Referring to FIG. 18, the electronic device may be implemented as a smartphone, but the invention is not limited thereto. The electronic device may be a television, a monitor, a laptop computer, or a tablet. Additionally, the electronic device may be a vehicle, e.g., an automobile.

The invention should not be construed as being limited to the embodiments set forth herein. Rather, these embodiments are provided so that this disclosure will be thorough and complete and will fully convey the concept of the invention to those skilled in the art.

The display apparatus according to embodiments may be applied to a display apparatus included in any electronic device or product including a display screen, such as a computer, a notebook, a mobile phone, a smart phone, a smart pad, a portable media player (PMP), a personal digital assistant (PDA), an MP3 player, or the like.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display apparatus comprising:
a display panel including a pixel;
a data driver which applies a data voltage based on a data signal to the pixel; and
a driving controller which receives input image data and outputs the data signal,
wherein the driving controller generates the data signal based on a luminance gain calculated based on a luminance recognition test data and a color sense gain calculated based on a color sense recognition test data.

2. The display apparatus of claim 1, wherein the data signal is generated based on a final gain, and
wherein the final gain is a product of the luminance gain and the color sense gain.

3. The display apparatus of claim 2, wherein a luminance level is determined based on the luminance recognition test data, and
wherein the luminance gain has a second luminance gain higher than a first luminance gain when the luminance level is in a second luminance level higher than a first luminance level.

4. The display apparatus of claim 2, wherein a luminance level is determined based on the luminance recognition test data, and
wherein when the luminance level is increased, the luminance gain is increased.

5. The display apparatus of claim 2, wherein the final gain includes a first color final gain, a second color final gain and a third color final gain,
wherein the first color final gain is a product of a first color sense gain and the luminance gain,
wherein the second color final gain is a product of a second color sense gain and the luminance gain, and
wherein the third color final gain is a product of a third color sense gain and the luminance gain.

6. The display apparatus of claim 5, wherein the first color sense gain is higher than a first reference gain when a color sense level determined based on the color sense recognition test data is in a first color sense level range,
wherein the second color sense gain is higher than a second reference gain when the color sense level is in a second color sense range different from the first color sense level range, and
wherein the third color sense gain is higher than a third reference gain when the color sense level is in a third color sense range different from the first color sense level range and the second color sense level range.

7. The display apparatus of claim 6, wherein the luminance recognition test data has a value determined based on a selected luminance selected from a test image, and the color sense recognition test data has a value based on a selected color selected from the test image, and
wherein when the selected color is a first color, the first color sense gain is a maximum color sense gain.

8. The display apparatus of claim 5, wherein a first color luminance of the display panel is controlled based on the first color final gain,
wherein a second color luminance of the display panel is controlled based on the second color final gain, and
wherein a third color luminance of the display panel is controlled based on the third color final gain.

9. The display apparatus of claim 1, wherein the luminance recognition test data has a value determined based on a selected luminance selected from a test image, and
wherein the color sense recognition test data has a value determined based on a selected color selected from the test image.

10. The display apparatus of claim 9, wherein the test image includes a luminance test image and a color sense test image,
wherein the luminance test image includes a first luminance image and a second luminance image,
wherein the first luminance image includes a first luminance region,
wherein the second luminance image includes a second luminance region having a luminance lower than a luminance of the first luminance region.

11. The display apparatus of claim 9, wherein the test image includes a luminance test image and a color sense recognition test image, and
wherein the color sense test image includes a first color region having a first color and a second color region having a second color different from the first color.

12. The display apparatus of claim 9, wherein the test image includes a luminance test image and a color sense test image, and
wherein the luminance test image includes a first luminance region, a second luminance region having a luminance lower than a luminance of the first luminance region and a third luminance region having a luminance lower than a luminance of the second luminance region.

13. The display apparatus of claim 1, wherein the driving controller includes:
a luminance data calculator which determines a luminance level based on the luminance recognition test data;
a color sense data calculator which determines a color sense level based on the color sense recognition test data;
a gain calculator which calculates a final gain based on the luminance level and the color sense level; and
a signal outputter which generates the data signal based on the final gain and the input image data.

14. The display apparatus of claim 13, wherein the driving controller further includes:
a stress converter which determines a deterioration of the display panel and outputs deterioration data corresponding to the deterioration of the display panel; and
a compensation signal generator which receives the deterioration data and the final gain, and outputs a compensation signal generated based on the deterioration data and the final gain.

15. A method of driving a display panel, the method comprising:
driving the display panel for displaying a test image;
receiving test data based on the test image;
calculating a luminance gain and a color sense gain based on the test data; and
generating a data signal based on the luminance gain and the color sense gain.

16. The method of claim 15, wherein the data signal is generated based on a final gain, and
wherein the final gain is a product of the luminance gain and the color sense gain.

17. The method of claim 16, wherein the test data includes a luminance recognition test data,
wherein a luminance level is determined based on the luminance recognition test data, and
wherein when the luminance level is increased, the luminance gain is increased.

18. The method of claim 16, wherein the test data includes a luminance recognition test data,
wherein a luminance level is determined based on the luminance recognition test data, and
wherein the luminance gain has a second luminance gain higher than a first luminance gain when the luminance level is in a second luminance level higher than a first luminance level.

19. The method of claim 16, wherein the final gain includes a first color final gain, a second color final gain and a third color final gain,
wherein the first color final gain is a product of a first color sense gain and the luminance gain,
wherein the second color final gain is a product of a second color sense gain and the luminance gain, and
wherein the third color final gain is a product of a third color sense gain and the luminance gain.

20. The method of claim 19, wherein the first color sense gain is higher than a first reference gain when a color sense level determined based on the test data is in a first color sense level range,
wherein the second color sense gain is higher than a second reference gain when the color sense level is in a second color sense range different from the first color sense level range, and
wherein the third color sense gain is higher than a third reference gain when the color sense level is in a third color sense range different from the first color sense level range and the second color sense level range.

21. An electronic device comprising:
a display panel including a pixel;
a data driver which applies a data voltage based on a data signal to the pixel;
a driving controller which receives input image data and outputs the data signal based on an input control signal; and
a processor which outputs the input control signal,
wherein the driving controller generates the data signal based on a luminance gain calculated based on a luminance recognition test data and a color sense gain calculated based on a color sense recognition test data.
